(19) United States
(12) Patent Application Publication
(10) Pub. No.: US 2012/0123682 A1
(43) Pub. Date: May 17, 2012

(54) METHOD AND SYSTEM FOR PRODUCING CLIMATE CRISIS INDEX

(76) Inventors: Jai Ho Oh, Busan (KR); Ok Yeon Kim, Busan (KR)

(21) Appl. No.: 13/387,278

(22) PCT Filed: Sep. 16, 2010
(86) PCT No.: PCT/KR10/06327

§ 371 Date: Jan. 26, 2012

(30) Foreign Application Priority Data
Feb. 25, 2010 (KR) KR10-2010-0016912

(51) Int. Cl. G06F 19/00; G01W 1/00

(52) U.S. Cl. 702/3

(57) ABSTRACT

The present invention relates to a method for producing a climate crisis index. The present invention provides a method for producing a climate crisis index as a indicator indicating the level of a risk according to climate change, wherein an average of the sum of the following indexes is produced as a climate crisis index: a carbon dioxide(CO₂) index using a carbon dioxide concentration in the atmosphere, a temperature index using a temperature anomaly, a food security index using food statistics, an energy security index using total electricity net generation, a water security index using precipitation, and a failed state index indicating vulnerability of countries. As described above, since the present invention is configured such that a climate crisis index is calculated quantitatively on an indexation basis based on various factors, an adaptive strategy against climate change can be effectively established and countermeasures against the climate change can be developed.

### TECHNICAL FIELD

The present invention relates to a method and system for producing a climate crisis index, and more particularly, to a method of and system for producing a climate crisis index, in which various factors are taken into consideration and an average of the sum of the values of the various factors is produced as a climate crisis index.

### BACKGROUND ART

Many places across the globe have suffered from global warming, climate change, and extreme weather events caused thereby. Currently, the common outlook of world weather and climate experts shows that the temperature and precipitation of the globe will increase by 2.0-3.8° C. and 3%, respectively, in the year 2100 due to the effects of the global warming and the climate change. According to a report of the Scientific Committee of Antarctic Research, if the global warming continues to get worse, islands in the ocean will sink into the water in 2100. In addition, the El Nino phenomenon exhausts water resources and greatly increases photosynthesis damage caused by environmental changes, so that plants can wither to death, and great natural disasters such as floods, subtropical diseases and the like can be caused.

According to the 4th report of the Intergovernmental Panel on Climate Change (IPPCC) issued in 2007, it is expected that the climate change due to the global warming will be further accelerated in the 21 century. Particularly, the progress rate of the climate change in the Korean peninsula exceeds the world average thereof. Furthermore, when taking account of the residence time of a greenhouse gas in the air, the establishment of climate changes impact assessment and adaptation measures must keep pace with that of greenhouse gas emission reduction measures. In other words, in order to set up adaptation measures based on accurate data and information on climate changes and abnormal climate phenomena caused by the climate changes occurring in all over the places in the world, a system must be supported which can monitor and predict the climate changes and can perform the assessment of the climate change impact and vulnerability.

Examples of existing indicator used to forecast the level of climate crisis include an environmental crisis clock, a doomsday clock, a world peace index, a common sense climate index, an environmental signal, a climate risk index, a climate confidence index, and the like. Such exemplified indicator, however, are still insufficient in various aspects and do not comprehensively reflect a variety of conditions.

Therefore, there is a need for the development of an index which includes a simpler and comprehensive content and is understood on a definite, objective and common sense basis. Furthermore, there is an indispensable and urgent need for the development of an index which secures availability, accessibility, security and stability, and considers vulnerability originated from risks and social factors according to natural phenomena.

### DISCLOSURE OF INVENTION

### Technical Problem

Accordingly, the present invention has been made in order to solve the above-described problems occurring in the prior art, and it is an object of the present invention to provide a method of and system for producing a climate crisis index based on various factors to predict climate change and variability.

### Solution to Problem

To achieve the above object in one aspect, the present invention provides a method of and system for producing a climate crisis index by taking a variety of factors into consideration.

According to the present invention, in the method for producing a climate crisis index as a indicator indicating the level of a risk due to climate change, an average of the sum of a carbon dioxide (CO₂) index using a carbon dioxide concentration in the atmosphere and a temperature index using a temperature anomaly is produced as a climate crisis index.

In this case, the carbon dioxide index is derived from the following Equation:

$${CO}_{2} index = \frac{x}{450 ppm} \times 100 \% ,$$

where x is a carbon dioxide concentration in the atmosphere.

More specifically, x is a carbon dioxide concentration in the atmosphere, which was measured at Mauna Loa Observatory to the U.S. Department of Commerce.

Also, the temperature index is derived from the following Equation:

$$Temperature index = \frac{Δ t}{5 °} \times 100 \% ,$$

where Δt is a temperature anomaly made by combining the data of a sea surface temperature and a ground surface temperature.

More specifically, Δt is a temperature anomaly calculated from the HadCRUT3 data, which is a global temperature data made by the Hadley Center of the UK Met Office and the Climate Research Unit (CRU) of the University of East Anglia in the UK.

In addition, in the climate crisis index calculating method of the present invention, an average of the sum of a food security index using food statistics, an energy security index using total electricity net generation and a water security index using precipitation to the sum of the carbon dioxide (CO₂) index and the temperature index may be produced as the climate crisis index. Further, an average of the sum of a failed state index indicating vulnerability of countries to the sum of the carbon dioxide (CO₂) index, the temperature index, the food security index, the energy security index and the water security index may be produced as the climate crisis index.

In this case, the food statistics employs the global market analysis data provided by the Food and Agricultural Organization of the United Nations.

In this case, the food security index is derived from the following Equation:

$$Food security index = \frac{\begin{matrix}food consumption \times \\ population growth rate\end{matrix}}{\begin{matrix}( food production \times cc\_impact ) + \\ ( food imports / world population growth rate )\end{matrix}} \times 100 \% ,$$

where cc_impact is an agricultural productivity impact index providing information regarding the effects of temperature increase, precipitation change and fossil fuel use for plants on the agricultural productivity, and is a projected change in agricultural productivity in 2080 due to climate change forced by the use of fossil fuels or the like.

In the meantime, the population growth rate employs data of “World Population Prospects: the 2008 Revision Population Database” provided by Population Division of the Department of Economics and Social Affairs.

Also, the energy security index is derived from the following Equation:

$$Energy security index = \frac{\begin{matrix}total electricity net generation \times \\ electricity price \times \\ population growth rate\end{matrix}}{0.1 \times GDP} \times 100 \% ,$$

where electricity price is a cost per kWh, and GDP is a gross domestic product (unit: one million US dollar).

The total electricity net generation (unit: one billion kWh) and the electricity Price (unit: US dollar/kWh) employ statistical data of the world total electricity net generation and electricity prices for households from the US Energy Information Administration.

Moreover, the water security index is derived from the following Equation:

$$Water security index = \frac{WPI \times \overline{{P}_{m}} \times population growth rate}{{P}_{i}}$$

where WPI is a water poverty index as an interdisciplinary measure which links household welfare with water availability and indicates the degree to which water scarcity impacts on human populations,

P̅ₘ̅ is an average precipitation for a period from 1950 to 2008, and

Pi is an annual precipitation.

The variables P̅ₘ̅ and Pi employ re-analysis data of precipitations collected jointly by the National Centers for Environmental Prediction (NCEP) and the National Center for Atmospheric Research (NCAR).

Also, the WPI (Water Poverty Index) employs a report of “The Water Poverty Index: an International Comparison” published by Centre for Economic Research to Keele University in the UK.

Meanwhile, the failed state index employs data published by the United States think-tank Fund for Peace and the magazine Foreign Policy.

In another aspect, the present invention provides a system for producing a climate crisis index including:

a carbon dioxide concentration collection module for collecting data of a carbon dioxide concentration in the atmosphere;

a carbon dioxide index calculation module for calculating the carbon dioxide index using the carbon dioxide concentration data collected by the carbon dioxide concentration collection module and Equation 1;

a temperature anomaly collection module for collecting a temperature anomaly;

a temperature index calculation module for calculating a temperature index using the temperature anomaly collected by the temperature anomaly collection module and Equation 2;

a population growth rate collection module for collecting the data of the population growth rate of a specific nation and the world population growth rate;

a food statistical data collection module for collecting the world food statistics;

a food security index calculation module for calculating food security index using the data of the population growth rates collected by the population growth rate collection module, the world food statistics collected by the food statistical data collection module, and Equation 3;

a electricity statistics and GDP collection module for collecting the data of total electricity net generation and electricity price, and the data of GDP;

an energy security index calculation module for calculating a energy security index using the data of the population growth rates collected by the population growth rate collection module, the data of total electricity net generation and electricity price and the data of GDP collected by the electricity statistics and GDP collection module, and Equation 4;

a water poverty index and precipitation collection module for collecting the data of the global water poverty index and the global precipitation;

a water security index calculation module for calculating a water security index using the data of the population growth rates collected by the population growth rate collection module, a water poverty index, the data of the global water poverty index and the global precipitation collected by the water poverty index and precipitation collection module, and Equation 5;

a failed state index collection module for collecting a failed state index indicating vulnerability of countries; and

an average calculation module for calculating an average of the sum of the carbon dioxide index, the temperature index, the food security index, the energy security index, the water security index and the failed state index calculated and collected by the carbon dioxide index calculation module, the temperature index calculation module, the food security index calculation module, the energy security index calculation module, the water security index calculation module and the failed state index collection module.

Herein, the above Equation 1 is written as follows:

$${CO}_{2} index = \frac{x}{450 ppm} \times 100 \% ,$$

where x is a carbon dioxide concentration in the atmosphere, which is collected by the carbon dioxide index calculation module and measured at Mauna Loa Observatory to the U.S. Department of Commerce.

In addition, the above Equation 2 is expressed as follows:

$$Temperature index = \frac{Δ t}{5 °} \times 100 \% ,$$

where Δt is a temperature anomaly made by combining the data of a sea surface temperature and a ground surface temperature collected by the temperature anomaly collection module and calculated based on the HadCRUT3 data, which is a global temperature data made by the Hadley Center of the UK Met Office and the Climate Research Unit (CRU) of the University of East Anglia in the UK.

In the meantime, the above Equation 3 is written as follows:

$$Food security index = \frac{\begin{matrix}food consumption \times \\ population growth rate\end{matrix}}{\begin{matrix}( food production \times cc\_impact ) + \\ ( food imports / world population growth rate )\end{matrix}} \times 100 \% ,$$

where cc_impact is a projected change in agricultural productivity in 2080 due to climate change forced by the use of fossil fuels or the like, and is an agricultural productivity impact index providing information regarding the effects of temperature increase, precipitation change and fossil fuel use for plants on the agricultural productivity, collected by the food statistical data collection module, and wherein the world food statistics employs the global market analysis data provided by the Food and Agricultural Organization of the United Nations, and.

Also, the above Equation 4 is written as follows:

$$Energy security index = \frac{\begin{matrix}total electricity net generation \times \\ electricity price \times \\ population growth rate\end{matrix}}{0.1 \times GDP} \times 100 \% ,$$

where electricity price is a cost per KWh, and GDP is a gross domestic product. The total electricity net generation and the electricity Price employ statistical data of the world total electricity net generation and electricity prices for households from the US Energy Information Administration.

Further, the above Equation 5 is written as follows:

$$Water security index = \frac{WPI \times \overline{{P}_{m}} \times population growth rate}{{P}_{i}} ,$$

where WPI is a water poverty index as an interdisciplinary measure which links household welfare with water availability, which is collected by the water poverty index and precipitation collection module, and employs a report of “The Water Poverty Index: an International Comparison” published by Centre for Economic Research to Keele University in the UK, is an average precipitation for a period from 1950 to 2008 collected by the water poverty index and precipitation collection module, P̅ₘ̅ and Pi is an annual precipitation collected by the water poverty index and precipitation collection module. The variables P̅ₘ̅ and Pi employ re-analysis data of precipitations collected jointly by the National Centers for Environmental Prediction (NCEP) and the National Center for Atmospheric Research (NCAR).

In the meantime, the population growth rate employs data of “World Population Prospects: the 2008 Revision Population Database” provided by Population Division of the Department of Economics and Social Affairs.

The failed state index employs data published by the United States think-tank Fund for Peace and the magazine Foreign Policy.

### Advantageous Effects of Invention

As described above, since the present invention is configured such that a climate crisis index is produced quantitatively on an indexation basis by taking into account various factors comprehensively, an adaptive strategy against climate change can be effectively established and countermeasures against the climate change can be developed.

### BRIEF DESCRIPTION OF DRAWINGS

FIG. 1 is a graph showing data of a carbon dioxide (CO₂) concentration in the atmosphere, which were measured at Mauna Loa Observatory;

FIG. 2 is a graph showing a carbon dioxide concentration obtained based on a linear interpolation, the measured data of FIG. 1 and an A1B scenario;

FIG. 3 is a graph showing a carbon dioxide index calculated by [Equation 1];

FIG. 4 is a graph showing a temperature anomaly calculated based on the HadCRUT3 data, which is a global temperature data made by the Hadley Center of the UK Met Office and the Climate Research Unit (CRU) of the University of East Anglia in the UK;

FIG. 5 is a graph showing a temperature index calculated by [Equation 2];

FIG. 6 is a table showing food (cereal) statistics provided by the Food and Agricultural Organization of the United Nations;

FIG. 7 is a map showing projected changes in agricultural productivity in 2080 due to climate change forced by the use of fossil fuels or the like;

FIG. 8 is a graph showing a population growth rate as data of “World Population Prospects: the 2008 Revision Population Database” provided by Population Division of the Department of Economics and Social Affairs;

FIG. 9 is a graph showing a food security index calculated by [Equation 3];

FIG. 10 is a statistical graph showing the world total electricity net generation provided by the US Energy Information Administration;

FIG. 11 is a graph showing world domestic electricity prices provided by the US Energy Information Administration;

FIG. 12 is a graph showing a Gross Domestic Product (GDP);

FIG. 13 is a graph showing an energy security index calculated by [Equation 4];

FIG. 14 is a graph showing re-analysis data of precipitations collected jointly by the National Centers for Environmental Prediction (NCEP) and the National Center for Atmospheric Research (NCAR);

FIG. 15 is graph showing a national water poverty index in a report of “The Water Poverty Index: an International Comparison” published by Centre for Economic Research to Keele University in the UK;

FIG. 16 is a graph showing a water security index calculated by [Equation 5];

FIGS. 17 and 18 are tables showing data indicating a failed state index by country released by the United States think-tank Fund for Peace and the magazine Foreign Policy;

FIG. 19 is a graph showing the failed state index of USA, India and South Korea;

FIG. 20 is a table showing statistical data indicating six factors and a climate crisis index of the U.S.;

FIG. 21 is a graph showing six factors and a climate crisis index of the U.S.;

FIG. 22 is a table showing statistical data indicating six factors and a climate crisis index of India;

FIG. 23 is a graph showing six factors and a climate crisis index of India;

FIG. 24 is a table showing statistical data indicating six factors and a climate crisis index of South Korea;

FIG. 25 is a graph showing six factors and a climate crisis index of South Korea;

FIG. 26 is a map showing the world climate crisis index in which indexation by color is implemented for easy understanding; and

FIG. 27 is a block diagram showing the entire construction of a system for producing an average of the sum of six factors as a climate crisis index in the present invention.

### BEST MODE FOR CARRYING OUT THE INVENTION

Hereinafter, factors to be considered to produce a climate crisis index (CCI) and a production method thereof according to the present invention will be described in more detail with reference to the accompanying drawings.

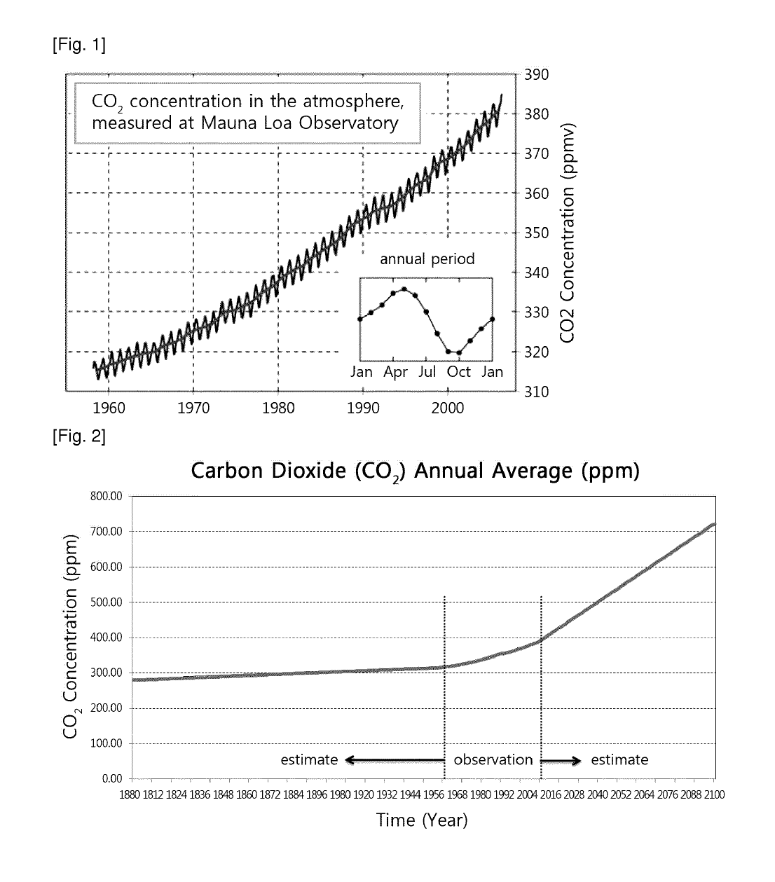

FIG. 1 is a graph showing data of a carbon dioxide (CO₂) concentration in the atmosphere as monthly observation data from 1958 to 2009, which were measured at Mauna Loa Observatory to the U.S. Department of Commerce.

FIG. 2 is a graph showing a carbon dioxide concentration obtained based on a linear interpolation, the measured data of FIG. 1 and an A 1B scenario.

Meanwhile, in the present invention, Equation 1 for calculating a carbon dioxide index to produce the climate crisis index is expressed as follows:

$${CO}_{2} index = \frac{x}{450 ppm} \times 100 \% , \qquad [ Equation 1 ]$$

where x is a carbon dioxide concentration in the atmosphere, which was measured at Mauna Loa Observatory to the U.S. Department of Commerce, and used observations of FIG. 1 from 1960 to 2010.

In the meantime, as shown in FIG. 2, data of the carbon dioxide concentration from 2010 to 2100 employed A1B scenarios (assuming that greenhouse gas emissions are assumed to follow a path that would stabilize carbon dioxide concentrations at 720 ppm) of various emission scenarios of the Special Report on Emission Scenario (SREA) prepared by the Intergovernmental Panel on Climate Change (IPCC). Also, data of the carbon dioxide concentration from 1910 to 1950 employed a linear interpolation of concentrations from 280 ppm (1800) to 320 ppm (1960).

Table 1 below shows numeric data indicating a carbon dioxide concentration (x) used in the present invention.

TABLE 1

| Decade | CO₂(ppm) |
|---|---|
| 1800 | 280.0 |
| 1810 | 282.0 |
| 1820 | 284.0 |
| 1830 | 286.0 |
| 1840 | 288.0 |
| 1850 | 290.0 |
| 1860 | 292.0 |
| 1870 | 294.0 |
| 1880 | 296.0 |
| 1890 | 298.0 |
| 1900 | 300.0 |
| 1910 | 303.0 |
| 1920 | 306.0 |
| 1930 | 309.0 |
| 1940 | 312.0 |
| 1950 | 316.0 |
| 1960 | 320.0 |
| 1970 | 330.0 |
| 1980 | 340.0 |
| 1990 | 350.0 |
| 2000 | 370.0 |
| 2010 | 390.0 |
| 2020 | 430.0 |
| 2030 | 470.0 |
| 2040 | 500.0 |
| 2050 | 540.0 |
| 2060 | 580.0 |
| 2070 | 610.0 |
| 2080 | 650.0 |
| 2090 | 690.0 |
| 2100 | 720.0 |

However, since instead of the most extreme A1B scenario (greenhouse gas emissions will increase continuously up to 720 ppm in 2100 at a current emission rate) of the emission scenarios, opinions of the academic world that greenhouse gas emissions will be reduced up to 70% socially and politically is determined to be more reasonable by climatologists, the percentage value obtained by dividing the greenhouse gas emissions (x) by 450 ppm was used as the carbon dioxide index in the atmosphere.

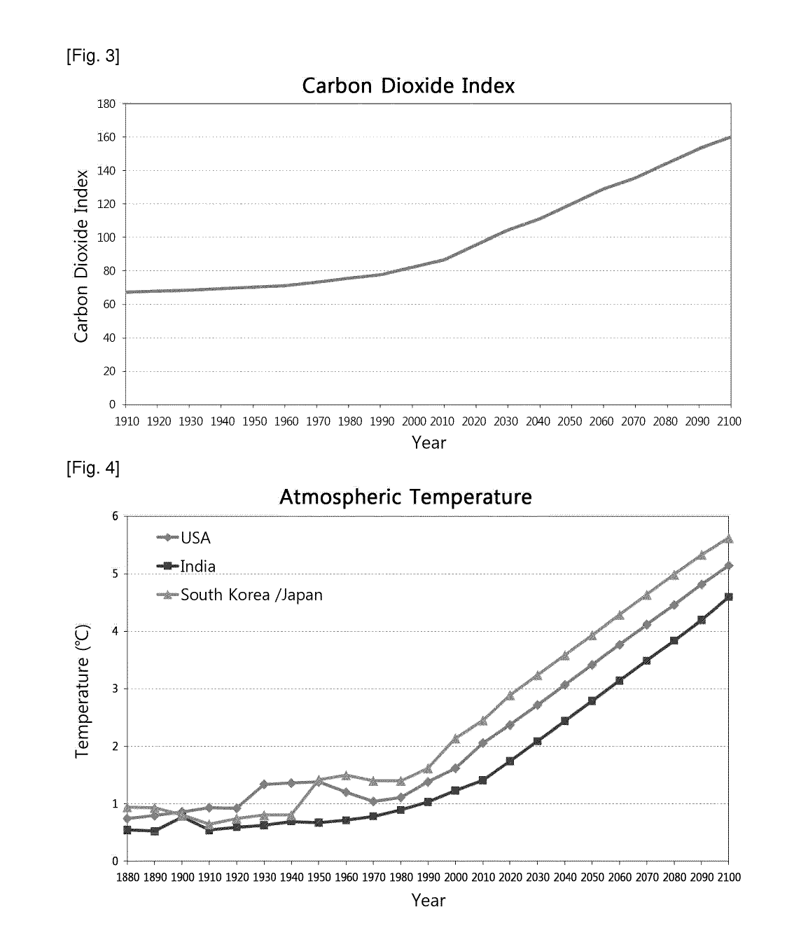

FIG. 3 is a graph showing a carbon dioxide index calculated by [Equation 1].

It can be seen as shown in FIG. 3 that the carbon dioxide index increases annually.

For example, in the case of the U.S., the carbon dioxide (CO₂) index in 2000 is calculated as follows:

CO₂ index=x/450ppm×100%=370/450ppm×100%=82.22.

FIG. 4 is a graph showing a temperature anomaly calculated based on the HadCRUT3 data, which is a global temperature data made by the Hadley Center of the UK Met Office and the Climate Research Unit (CRU) of the University of East Anglia in the UK. The temperature anomaly is data of a monthly temperature anomaly from January 1850 to July 2008, which was made by combining the data of a sea surface temperature and a ground surface temperature.

In the meantime, in the present invention, Equation 2 for calculating a temperature index to produce the climate crisis index is expressed as follows:

$$Temperature index = \frac{Δ t}{5 °} \times 100 \% , \qquad [ Equation 2 ]$$

where Δt a temperature anomaly made by combining the data of a sea surface temperature and a ground surface temperature. More specifically, Δt is a temperature anomaly calculated based on the HadCRUT3 data, which is a global temperature data made by the Hadley Center of the UK Met Office and the Climate Research Unit (CRU) of the University of East Anglia in the UK. The global temperature data has a resolution of 5°×5° over the global area, and the temperature anomaly is calculated by an area average of the temperatures for a target area.

The researches on a global temperature change up to 2100 in the future predicts that the global temperature will increase from 16.5° C. (+1.8° C.) to 19.9° C. (+5.2° C.) relative to an average global temperature of 14.7° C. in the present 2000. Thus, a change in the global temperature from 2009 to 2100 employed a temperature anomaly which increased at an annual ratio of 0.035° C./year relative to 3.5° C./100 years as an intermediate value thereof. A change in the global temperature from 1910 to 2008 employed a temperature anomaly value calculated based on the HadCRUT3 data.

In addition, since reports on the economics of climate change predicts that even if the temperature increase merely by 5° C., serious problems will be caused in foods, water gates, ecosystems, marine organisms, heath and the like, the percentage value obtained by dividing a temperature anomaly(Δt) by 5° C. was used as the temperature index.

Table 2 below shows numeric data indicating a temperature anomaly (Δt) used in the present invention.

TABLE 2

| Year | USA |
|---|---|
| 1880 | 0.74 |
| 1890 | 0.79 |
| 1900 | 0.86 |
| 1910 | 0.93 |
| 1920 | 0.92 |
| 1930 | 1.34 |
| 1940 | 1.36 |
| 1950 | 1.38 |
| 1960 | 1.20 |
| 1970 | 1.04 |
| 1980 | 1.11 |
| 1990 | 1.38 |
| 2000 | 1.62 |
| 2010 | 2.06 |
| 2020 | 2.37 |
| 2030 | 2.72 |
| 2040 | 3.07 |
| 2050 | 3.42 |
| 2060 | 3.77 |
| 2070 | 4.12 |
| 2080 | 4.46 |
| 2090 | 4.82 |
| 2100 | 5.15 |

For example, in the case of the U.S., the temperature index in 2000 is calculated as follows by using [Equation 2] and [Table 2]:

Temperature index=Δt/5°×100%=1.62/5×100%=32.40.

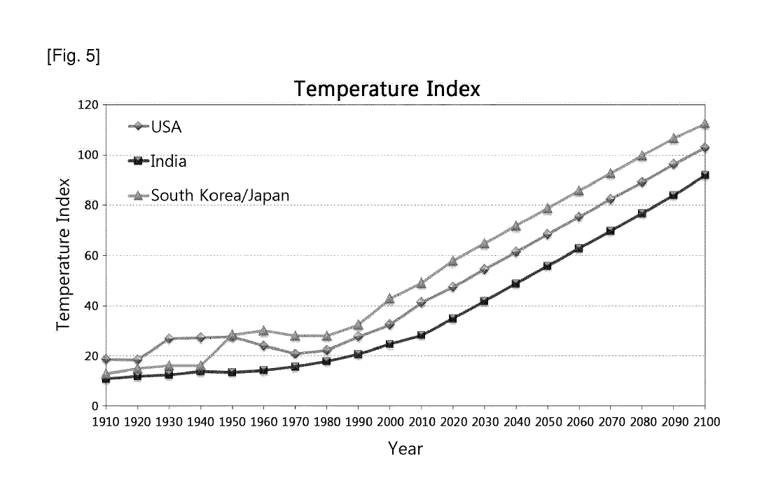

FIG. 5 is a graph showing a temperature index calculated by [Equation 2].

It can be seen as shown in FIG. 5 that the temperature index increases annually all over the world.

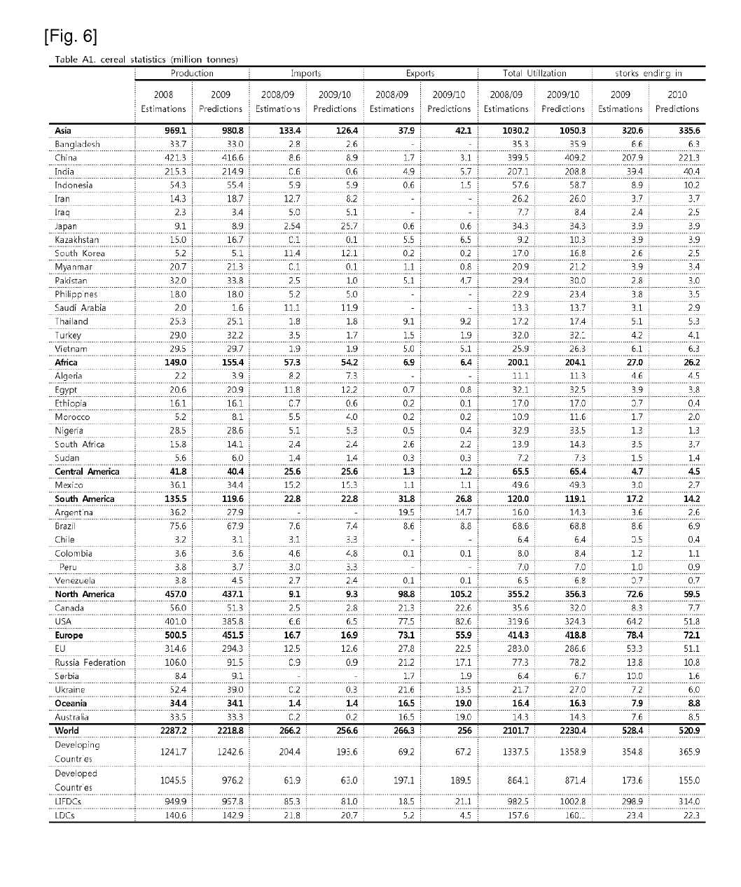

FIG. 6 is a table showing food (cereal) statistics provided by the Food and Agricultural Organization of the United Nations, which is global market analysis data released on June 2009.

In the meantime, in the present invention, Equation 3 for calculating a food security index to produce the climate crisis index is expressed as follows:

$$Food security index = \frac{\begin{matrix}food consumption \times \\ population growth rate\end{matrix}}{\begin{matrix}( food production \times cc\_impact ) + \\ ( food imports / world population growth rate )\end{matrix}} \times 100 \% \qquad [ Equation 3 ]$$

As shown in FIG. 6, the food statistics of the main countries of Asia, Africa, America, Europe and Oceania is provided by the Food and Agricultural Organization of the United Nations and the global market analysis data released on June 2009 was used. The data includes statistics of food productions, exports and imports, total utilization (or consumption) and stocks from 2008 to 2009, and food projection data in 2010. Estimated values of food productions/imports/consumption in 2009 were used over the entire period (from 1910 to 2100) for calculation.

For example, in the case of the U.S., the predicted values of food productions/imports/consumption in 2009 are 385.8, 6.5 and 324.3 million tons, respectively, and the same values were used over the entire period (from 1910 to 2100).

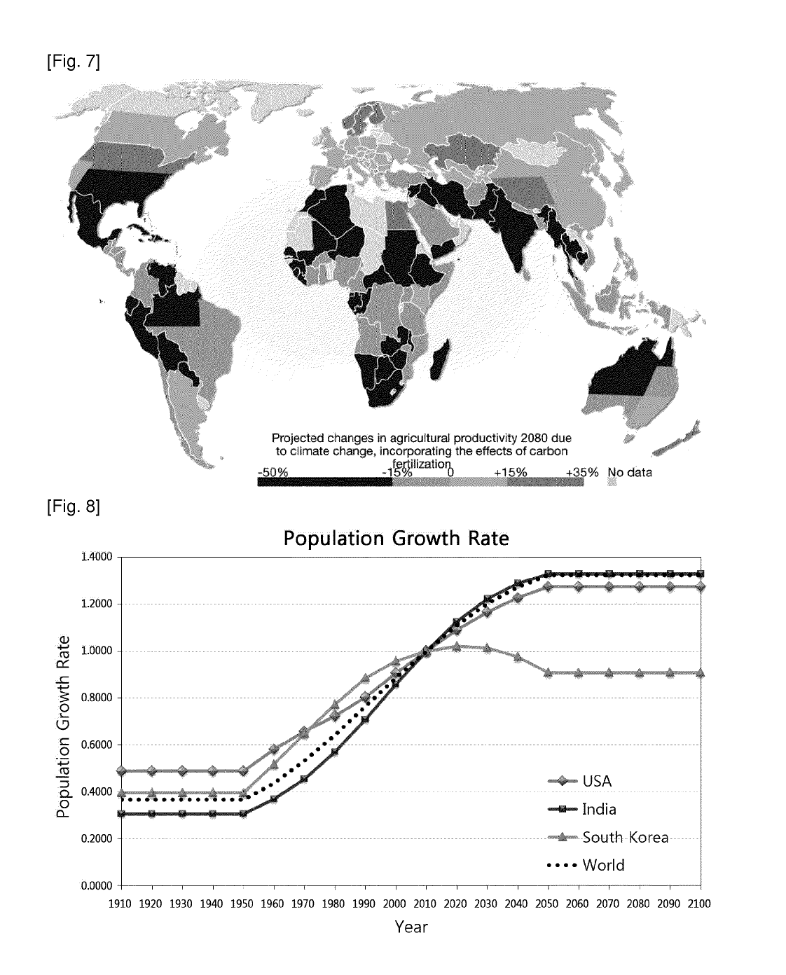

FIG. 7 is a map showing projected changes in agricultural productivity in 2080 due to climate change forced by the use of fossil fuels or the like.

In this case, the projected changes in agricultural productivity in 2080 due to climate change forced by the use of fossil fuels or the like shown in FIG. 7 was used as cc_impact of [Equation 3], which provides schematic information regarding the effects of temperature increase, precipitation change and fossil fuel use for plants on the agricultural productivity. Thus, in order to calculate the food security index of the present invention, a cc_impact index of 1.0 was used from 1910 to 2000 and a linear interpolation based on the projected changes in agricultural productivity in 2080 was used for the estimation of cc_impact from 2010 to 2100.

More specifically, the cc_impact as an agricultural productivity impact index made reference to the projected changes in agricultural productivity in 2080 due to climate change forced by the use of fossil fuels or the like, and the agricultural productivity impact index employed a cc_impact index of 1.0 in the present 2000s and for the period from 1910 to 2100 in order to calculate the cc_impact. Also, the agricultural productivity impact index from 2010 to 2080 employed a linear interpolation based on a figure showing the projected changes in agricultural productivity in 2080, and the agricultural productivity impact index from 2080 to 2100 is the same as that in 2080.

For example, in the case of the U.S., a deep red color (from −15% to −50%, intermediate value −32.5%) occupies 45%, a deep green color (from +15% to +35%, intermediate value +25%) occupies 45%, and a pale green color (from 0 to +15%, intermediate value +7.5%) occupies 10%. From the above percentages, a calculated result of cc_impact. is as follows:

[(−0.325×0.45)+(0.25×0.45)+(0.075×0.1)]=−0.0263. Thus, the agricultural productivity of the U.S. in 2080 decreases by approximately 0.026 relative to 1.0 in the present 2000 so that the cc_impact in 2080 becomes 0.974. Accordingly, when the values ranging from 1.0 in 2000 to 0.974 in 2080 undergoes a linear interpolation, the results are shown in Table 3 below.

TABLE 3

| Year | USA |
|---|---|
| 1900 | 1.0000 |
| 1910 | 1.0000 |
| 1920 | 1.0000 |
| 1930 | 1.0000 |
| 1940 | 1.0000 |
| 1950 | 1.0000 |
| 1960 | 1.0000 |
| 1970 | 1.0000 |
| 1980 | 1.0000 |
| 1990 | 1.0000 |
| 2000 | 1.0000 |
| 2010 | 0.9967 |
| 2020 | 0.9934 |
| 2030 | 0.9901 |
| 2040 | 0.9868 |
| 2050 | 0.9835 |
| 2060 | 0.9802 |
| 2070 | 0.9759 |
| 2080 | 0.9740 |
| 2090 | 0.9740 |
| 2100 | 0.9740 |

FIG. 8 is a graph showing data of “World Population Prospects: the 2008 Revision Population Database” provided by Population Division of the Department of Economics and Social Affairs, which indicates the population growth rates of relevant countries and the world population growth rate.

According to the estimates released in 2009 by the Food and Agricultural Organization (FAO) of the United Nations (UN), about 1.02 billion people suffer from hungry every day all over the world, which corresponds to one of seven people in the world population. That is, one of factors having the greatest effect on food crisis is just the population growth rate. The data of “World Population Prospects: the 2008 Revision Population Database” provided by Population Division of the Department of Economics and Social Affairs was used to take the population growth rate into consideration. From the above data, a population growth rate in 2010 is set to 1.0 and the population growth rates for the remaining years were calculated based on the ratio. It was assumed that the population growth rate from 1910 to 1950 and the population growth rate from 2050 to 2100 are the same as that in 1950 and 2050, respectively. For example, in the case of the U.S., the population growth rate is 0.91 in 2000. The world population growth rate was also calculated in the same manner, and the world population growth rate is 0.89 in 2000.

Consequently, a food security index calculated by [Equation 3] based on the specified data of the U.S. in 2000 is as follows:

324.3×0.91/[(385.8×1.0)+(6.5/0.89)]×100%=75.07.

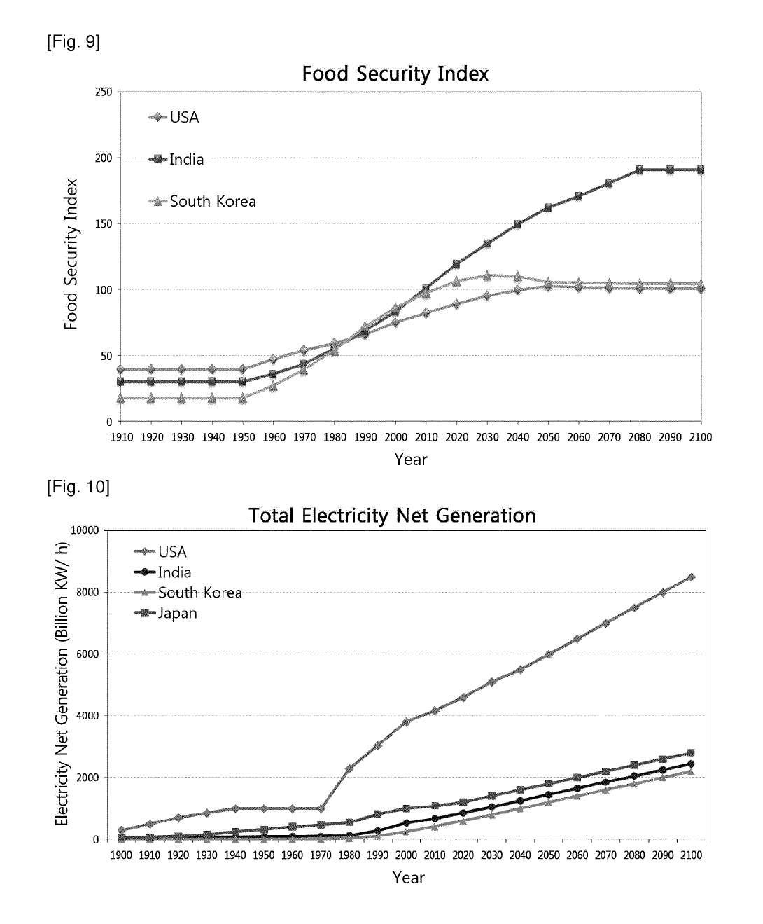

FIG. 9 is a graph showing a food security index calculated by [Equation 3].

It can be seen as shown in FIG. 9 that the food security index increases for several years in the future annually all over the world.

FIG. 10 is a statistical graph showing the world total electricity net generation provided by the US Energy Information Administration.

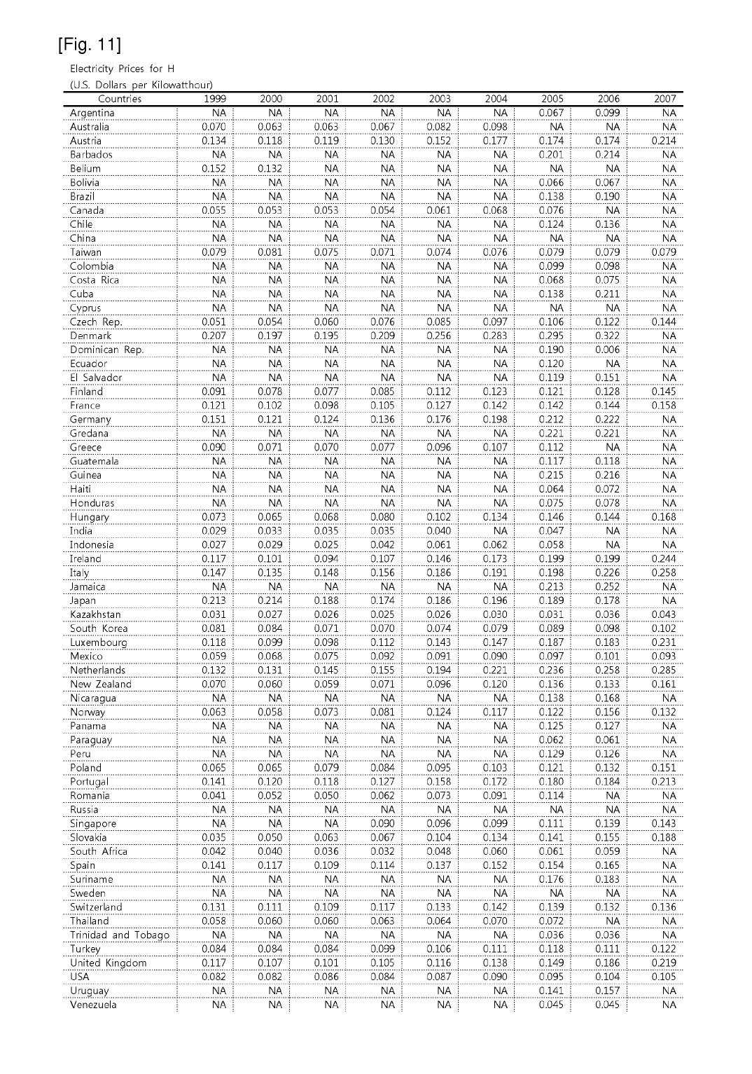

FIG. 11 is a graph showing world domestic electricity prices (unit: penny/kWh) (NA: Not Available) provided by the US Energy Information Administration.

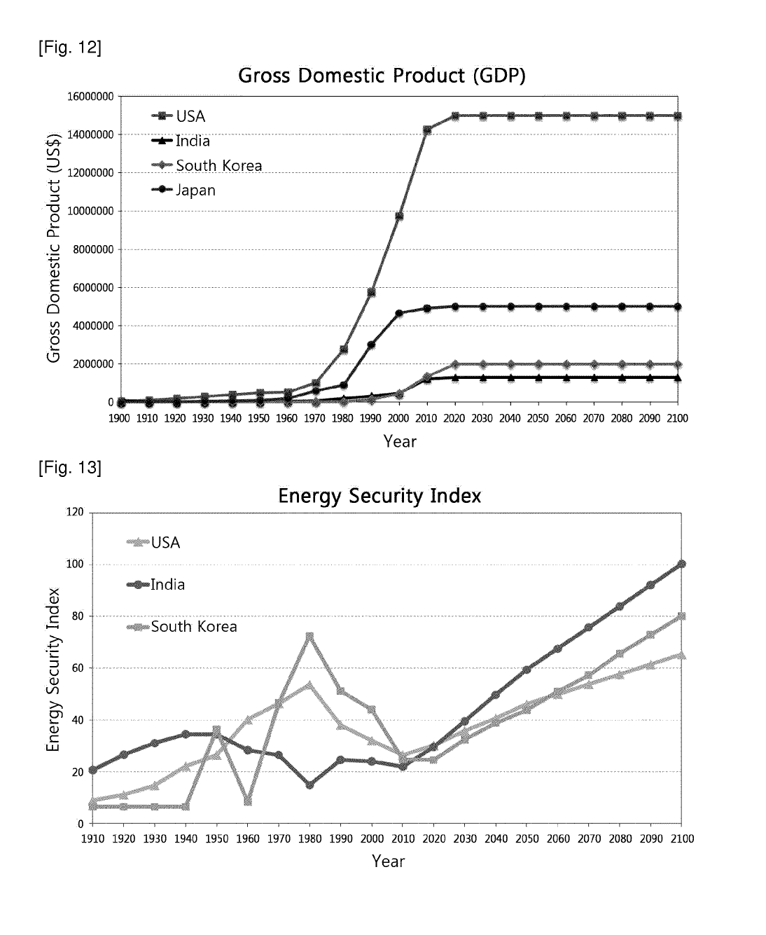

FIG. 12 is a graph showing a Gross Domestic Product (GDP).

In the meantime, in the present invention, Equation 2 for calculating an energy security index to produce the climate crisis index is expressed as follows:

$$Energy security index = \frac{\begin{matrix}total electricity net generation \times \\ electricity price \times population growth rate\end{matrix}}{0.1 \times GDP} \times 100 \% , \qquad [ Equation 4 ]$$

where electricity price is a cost per KWh, and GDP is a gross domestic product. More specifically, the total electricity net generation and the electricity price employed statistical data of the world total electricity net generation and electricity prices for households from the US Energy Information Administration, respectively.

A total electric energy provided from the above data includes heat electric energy, hydro-electric energy, nuclear energy, regional energy, solar energy, wind energy and the like. The period provided from the above data ranges from 1980 to 2010. Thus, actual values of the total electricity net generation were used for this period. Also, the world electric energy generation increasing rate was calculated in view of an increase rate of 23.2 trillion wons/kWh in 2015 and 31.8 trillion won/kWh in 2030 relative to 18 trillion wons/kWh in 2006. The electric energy generation increasing rate for the period ranging from 2010 to 2100 was estimated by using the same increasing rate. The world domestic electricity prices provided by the US Energy Information Administration collectively used an average of electricity prices from 1999 to 2070. In the case of the U.S., the total electricity net generation and the electricity price are shown in Table 4 below as follows:

TABLE 4

| Year | USA | rate(KW price) |
|---|---|---|
| 1900 | 10.00 | 0.09 |
| 1910 | 20.00 | 0.09 |
| 1920 | 50.00 | 0.09 |
| 1930 | 100.00 | 0.09 |
| 1940 | 200.00 | 0.09 |
| 1950 | 300.00 | 0.09 |
| 1960 | 400.00 | 0.09 |
| 1970 | 800.00 | 0.09 |
| 1980 | 2289.00 | 0.09 |
| 1990 | 3041.00 | 0.09 |
| 2000 | 3808.00 | 0.09 |
| 2010 | 4167.00 | 0.09 |
| 2020 | 4600.00 | 0.09 |
| 2030 | 5100.00 | 0.09 |
| 2040 | 5500.00 | 0.09 |
| 2050 | 6000.00 | 0.09 |
| 2060 | 6500.00 | 0.09 |
| 2070 | 7000.00 | 0.09 |
| 2080 | 7500.00 | 0.09 |
| 2090 | 8000.00 | 0.09 |
| 2100 | 8500.00 | 0.09 |

In the case of the U.S., the total electricity net generation and the electricity price in 2000 are 3808.00 billions kW/h and 0.09 US Dollars per kWh, respectively.

In FIG. 12, the gross domestic product (GDP) is an indicator representing the total value of all goods and services produced over a specific time period. Since energy generation/consumption is also closely related to the gross domestic product (GDP), data provided by DDP Quick Query selected from the World Development Indicators of the World Bank Group was used. This data can be found in the homepage of the World Bank Group. Since the data provides the GDP collected for the period ranging from 1960 to 2008, the data of FIG. 12 was used for the period ranging from 1910 to 2050. For the period before 1960 and after 2008 for which data is not provided, a GDP linearly estimated based on past variations was used. In the case of the U.S., the GDP is shown in [Table 5]. According to [Table 5], the GDP of the USA in 2000 is 9,764,800 US dollars.

TABLE 5

| Year | USA |
|---|---|
| 1820 | 12548.00 |
| 1870 | 98374.00 |
| 1900 | 40000.00 |
| 1910 | 100000.00 |
| 1920 | 200000.00 |
| 1930 | 300000.00 |
| 1940 | 400000.00 |
| 1950 | 500000.00 |
| 1960 | 520531.00 |
| 1970 | 1025000.00 |
| 1980 | 2768900.00 |
| 1990 | 5757200.00 |
| 2000 | 9764800.00 |
| 2010 | 15000000.00 |
| 2020 | 15000000.00 |
| 2030 | 15000000.00 |
| 2040 | 15000000.00 |
| 2050 | 15000000.00 |
| 2060 | 15000000.00 |
| 2070 | 15000000.00 |
| 2080 | 15000000.00 |
| 2090 | 15000000.00 |
| 2100 | 15000000.00 |

FIG. 13 is a graph showing an energy security index calculated by [Equation 4].

It can be seen as shown in FIG. 13 that the energy security index of South Korea decreases for the period from 1980 to 2010, and again increases annually.

The energy security index calculated based on a specific data of the USA in 2000 is as follows:

[3808.00×0.09×0.91)×1000/(0.1×9764800)]×100%=31.94,

where 1000 by which a numerator of the fraction is multiplied is a value multiplied to match the units between billion of the electricity generation in the numerator and million of the GDP in the denominator.

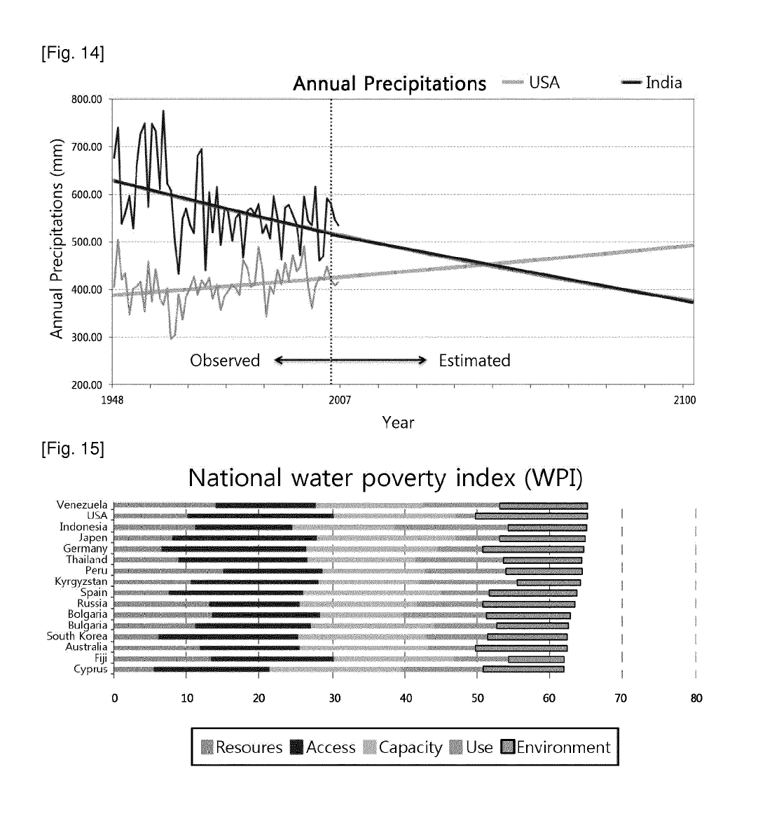

FIG. 14 is a graph showing re-analysis data of precipitations collected jointly by the National Centers for Environmental Prediction (NCEP) and the National Center for Atmospheric Research (NCAR).

In the case of the U.S., the re-analysis data of precipitations (unit: mm) is shown in [Table 6] as follows:

TABLE 6

| Year | USA |
|---|---|
| 1910 | 400 |
| 1920 | 400 |
| 1930 | 405 |
| 1940 | 405 |
| 1950 | 411 |
| 1960 | 381 |
| 1970 | 398 |
| 1980 | 407 |
| 1990 | 426 |
| 2000 | 431 |
| 2010 | 438 |
| 2020 | 445 |
| 2030 | 452 |
| 2040 | 459 |
| 2050 | 466 |
| 2060 | 473 |
| 2070 | 480 |
| 2080 | 487 |
| 2090 | 494 |
| 2100 | 500 |

FIG. 15 is graph showing a national water poverty index in a report of “The Water Poverty Index: an International Comparison” published by Centre for Economic Research to Keele University in the UK.

In the case of the U.S., the water poverty index is shown in [Table 7] as follows:

TABLE 7

| Year | USA |
|---|---|
| 1910 | 65.0 |
| 1920 | 65.0 |
| 1930 | 65.0 |
| 1940 | 65.0 |
| 1950 | 65.0 |
| 1960 | 65.0 |
| 1970 | 65.0 |
| 1980 | 65.0 |
| 1990 | 65.0 |
| 2000 | 65.0 |
| 2010 | 65.0 |
| 2020 | 65.0 |
| 2030 | 65.0 |
| 2040 | 65.0 |
| 2050 | 65.0 |
| 2060 | 65.0 |
| 2070 | 65.0 |
| 2080 | 65.0 |
| 2090 | 65.0 |
| 2100 | 65.0 |

In the meantime, in the present invention, Equation 5 for calculating a water security index to produce the climate crisis index is expressed as follows:

$$Water security index = \frac{\begin{matrix}WPI \times \overline{{P}_{m}} \times \\ population growth rate\end{matrix}}{{P}_{i}} , \qquad [ Equation 5 ]$$

where WPI is a water poverty index as an interdisciplinary measure which links household welfare with water availability and indicates the degree to which water scarcity impacts on human populations,

P̅ₘ̅ is an average precipitation for a period from 1950 to 2008, and

Pi is an annual precipitation.

The variables P̅ₘ̅ and Pi employed precipitation data from 1948 to 2008 as reanalysis data of precipitations collected jointly by the National Centers for Environmental Prediction (NCEP) and the National Center for Atmospheric Research (NCAR) as shown in FIG. 14. Precipitation data undergoing a linear interpolation was used for the period before 1948 and after 2009 which is not included in the NCEP/NCAR re-analysis data.

The WPI used in Equation 5 employed a report of “The Water Poverty Index: an International Comparison” published by Centre for Economic Research to Keele University in the UK. The purpose of the water poverty index is to express an interdisciplinary measure which links household welfare with water availability and indicate the degree to which water scarcity impacts on human populations. The use of this water poverty index can divide classes by country in consideration of a physical, social and economic aspect in regard to water scarcity. In addition, this water poverty index enables a national or international authority in charge of supply and management of water resources to monitor social and economic factors having an effect on the present available resource and the use of this available resource. Information on a total of 140 countries is contained in the report (Lawrence, P., Meight, J., and Sullivan, C. (2002). “The Water Poverty Index: an International Comparison”, Keele Economics Research Papers, 19, October, pp. 1-17).

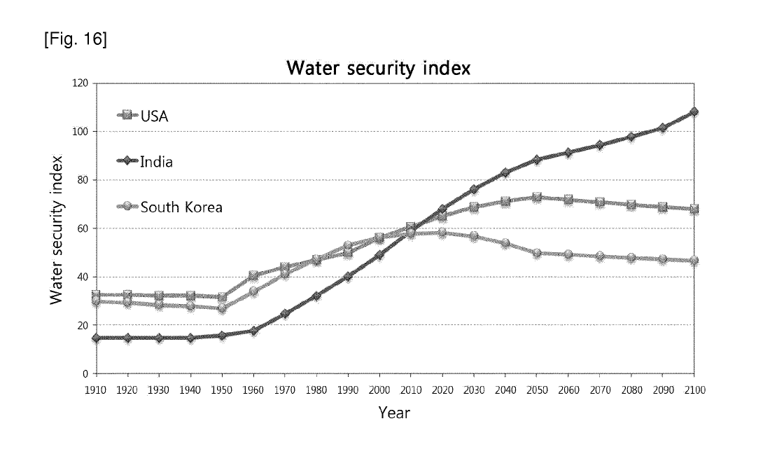

FIG. 16 is a graph showing a water security index calculated by [Equation 5].

It can be seen as shown in FIG. 16 that the water security index increases gradually worldwide.

The water security index of the USA in 2000 calculated by [Equation 5] is as follows:

(65.0×409×0.91)/431=56.13.

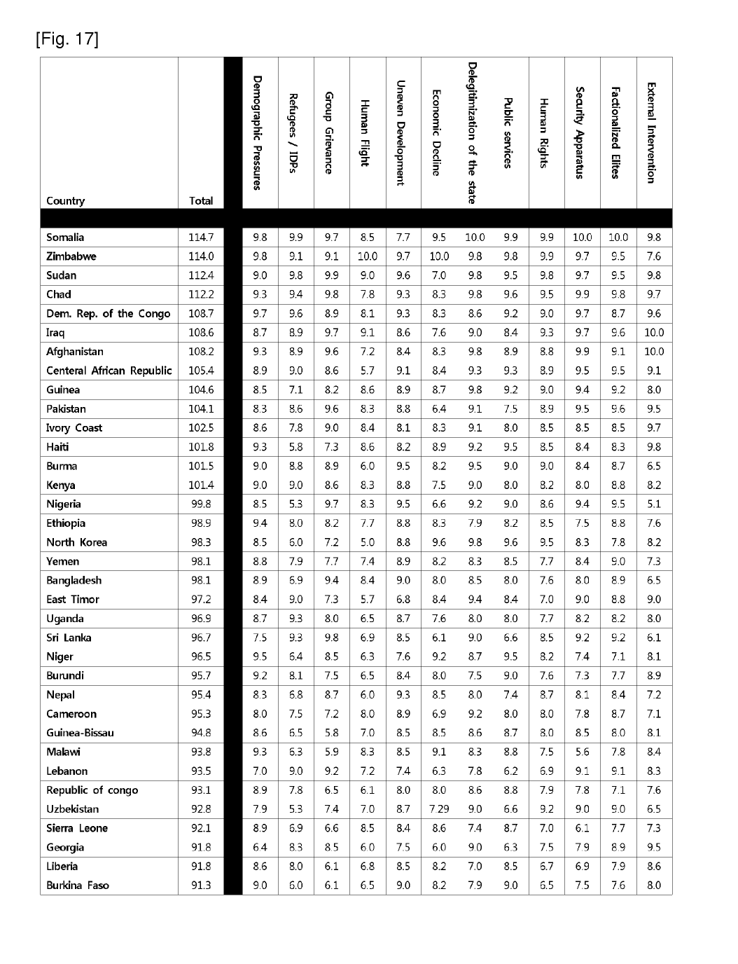

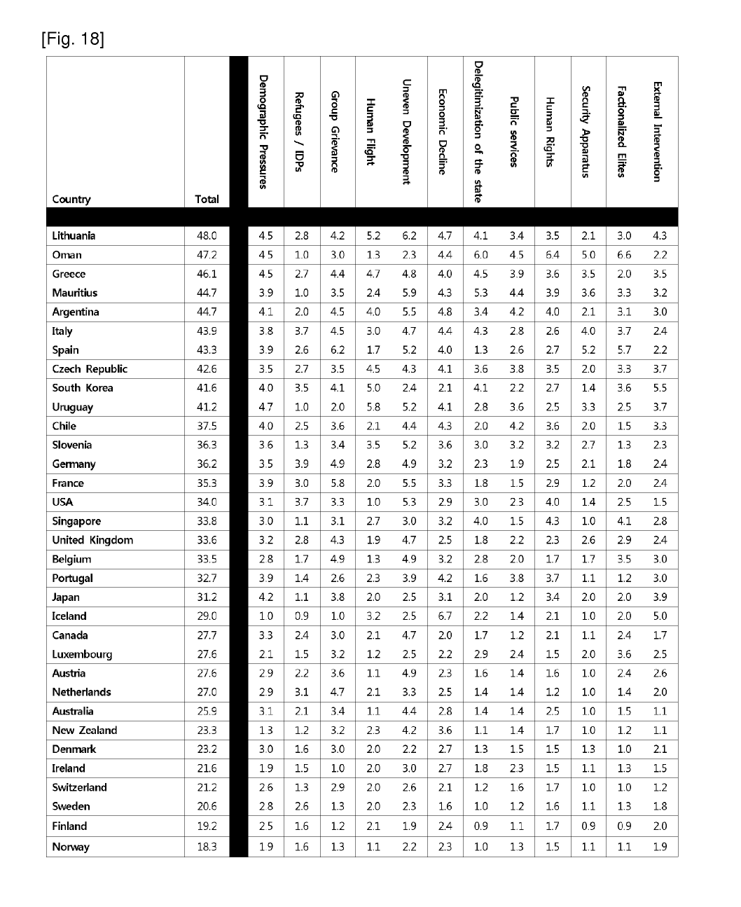

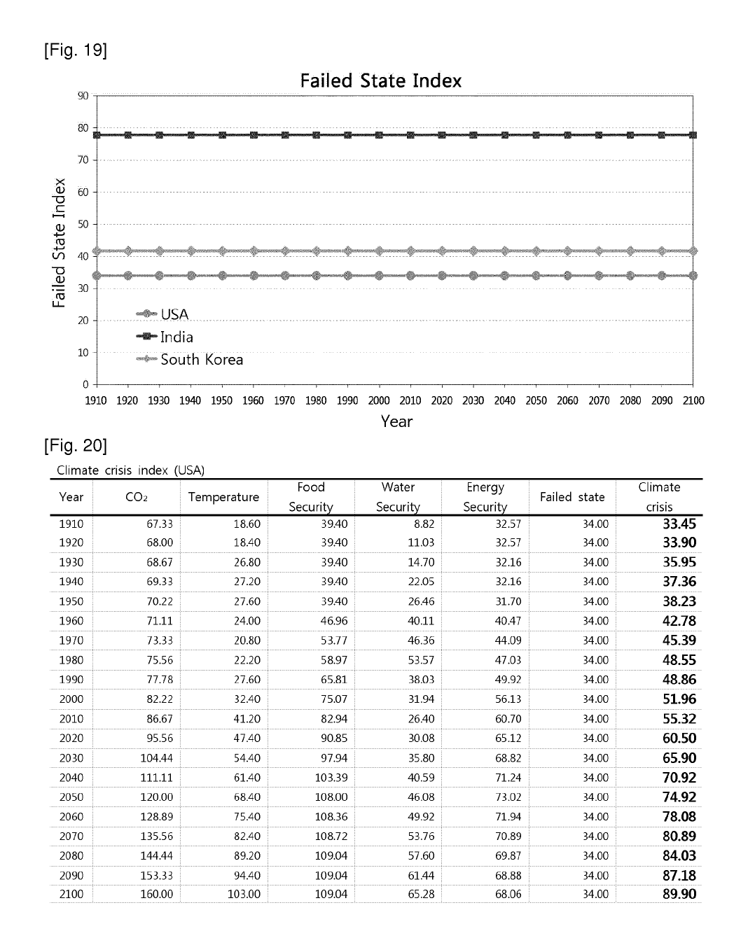

FIGS. 17 and 18 are tables showing data indicating a failed state index by country released by the United States think-tank Fund for Peace and the magazine Foreign Policy. Also, FIG. 19 is a graph showing the failed state index of USA, India and South Korea;

In the meantime, in the present invention, the failed state index calculated to produce the climate crisis index employed the data released by the United States think-tank Fund for Peace and the magazine Foreign Policy.

The failed state index is one calculated based on several characteristics, which represents a state in which a central government of one nation does not have an actual influence on and does not rule over a territory of the nation, vulnerable public service, corruption and crime prevalent in the society, unconscious migration of refugees and populations, and the like due to high vulnerability or ineffectiveness, which finally results in a sharp drop in economic activity. This failed state index represents a more stable state as it becomes lower and represents a more instable state as it becomes higher.

Based on six factors including the carbon dioxide index, the temperature index, the food security index, the energy security index, the water security index and the failed state index, an average of the sum of the values of the factors is calculated to produce the climate crisis index of the present invention. That is, the climate crisis index (CCI) is derived from the following [Equation 6]:

$$CCI = \frac{1}{6} [ \begin{matrix}carbon dioxide index + temperature index + \\ food security index + energy security index + \\ water security index + failed state index\end{matrix} ] \qquad [ Equation 6 ]$$

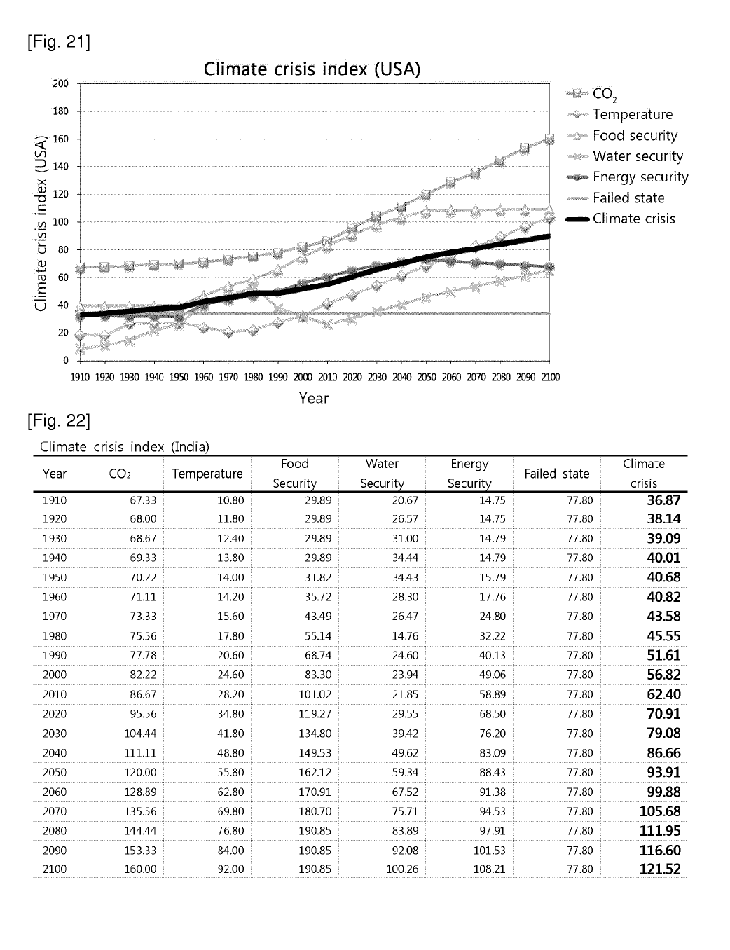

FIG. 20 is a table showing statistical data indicating six factors and a climate crisis index of the U.S., and FIG. 21 is a graph showing six factors and a climate crisis index of the U.S.

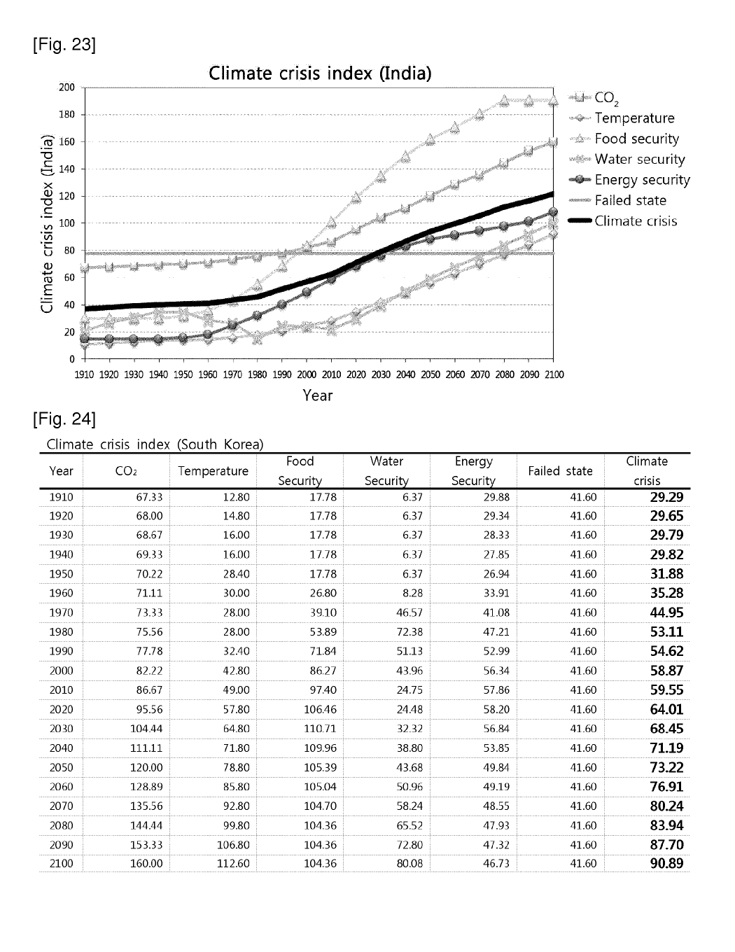

FIG. 22 is a table showing statistical data indicating six factors and a climate crisis index of India, and FIG. 23 is a graph showing six factors and a climate crisis index of India.

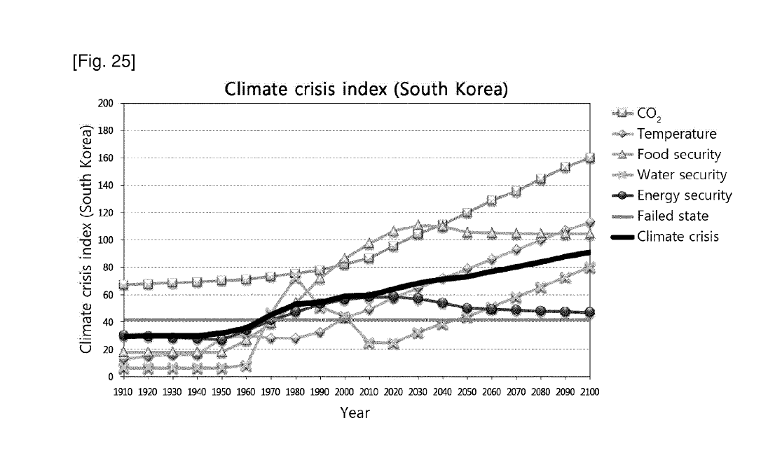

FIG. 24 is a table showing statistical data indicating six factors and a climate crisis index of South Korea, and FIG. 25 is a graph showing six factors and a climate crisis index of South Korea.

The climate crisis indexes, and the carbon dioxide index, the temperature index, the food security index, the energy security index, the water security index and the failed state index shown in FIGS. 20 to 25 means that a degree of risk becomes lower as the indexes are smaller and becomes higher as the indexes are larger. For example, in the case of India, the climate crisis index exceeds 100 in 2070 so that the degree of risk is high. On the other hand, in the case of the U.S., the climate crisis index is less than 100 in 2100 so that the degree of risk is relatively low. More specifically, when the climate crisis index of the U.S. in 2000 is calculated as follows:

CCI=(82.22+32.40+75.07+31.94+56.13+34.00)/6=51.96.

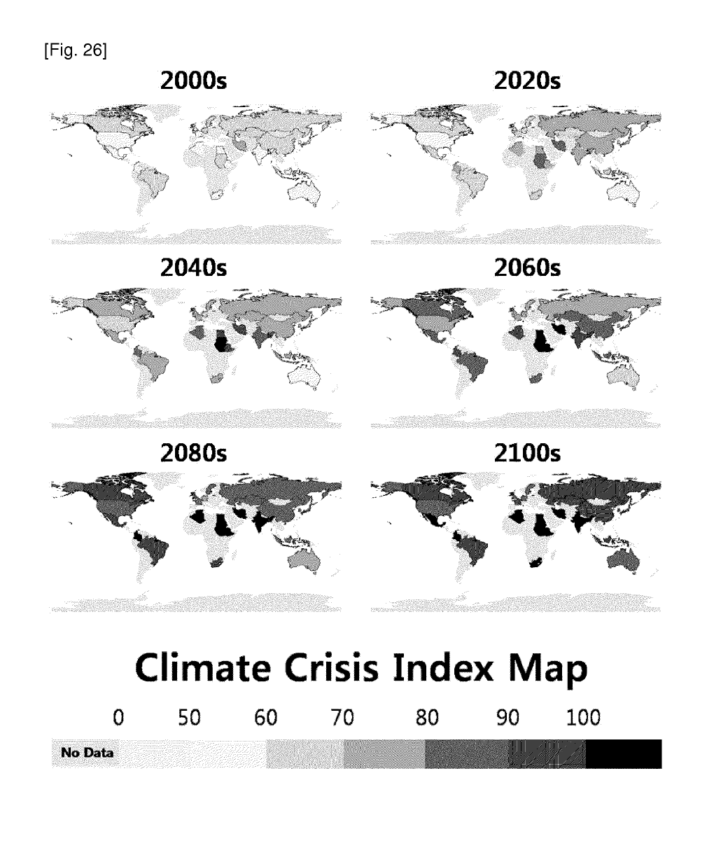

FIG. 26 is a map showing the world climate crisis index in which indexation by color is implemented for easy understanding. That is, the climate crisis index is divided into the following eight groups by color, including no data, 0-50, 50-60, 60-70, 70-80, 80-90, 90-100, 100 or more, so that relevant regions on the map can be displayed by each color.

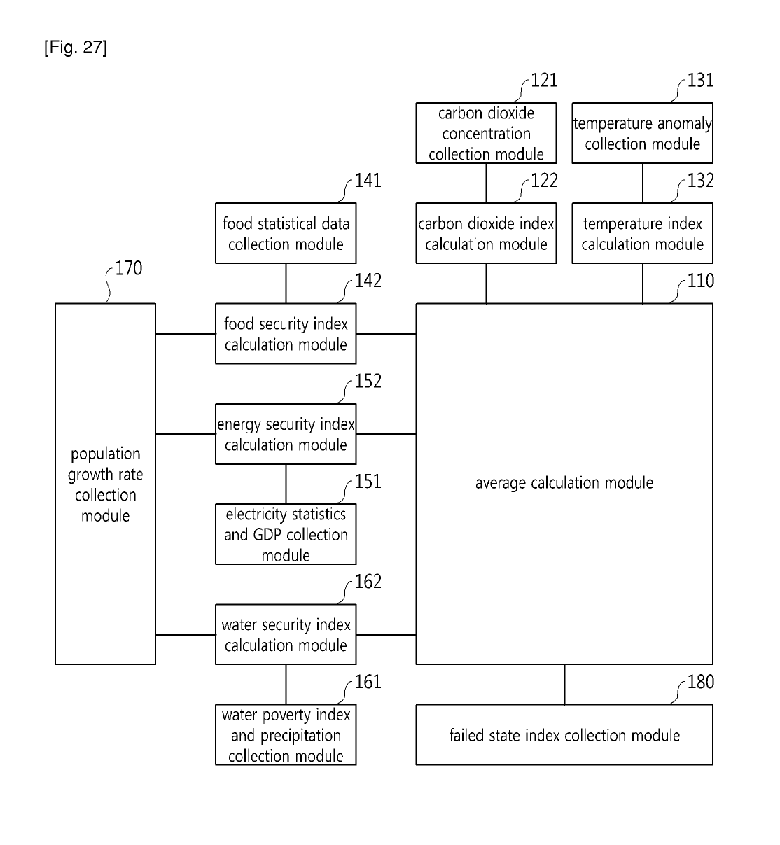

FIG. 27 is a block diagram showing the entire construction of a system for producing an average of the sum of six factors as a climate crisis index in the present invention.

As shown in FIG. 27, the climate crisis index producing system of the present invention includes: a carbon dioxide concentration collection module 121 for collecting data of a carbon dioxide concentration in the atmosphere; a carbon dioxide index calculation module 122 for calculating the carbon dioxide index using the carbon dioxide concentration data collected by the carbon dioxide concentration collection module 121 and Equation 1; a temperature anomaly collection module 131 for collecting a temperature anomaly; a temperature index calculation module 132 for calculating a temperature index using the temperature anomaly collected by the temperature anomaly collection module 131 and Equation 2; a population growth rate collection module 170 for collecting the data of the population growth rate of a specific nation and the world population growth rate; a food statistical data collection module 141 for collecting the world food statistics; a food security index calculation module 142 for calculating food security index using the data of the population growth rates collected by the population growth rate collection module, the world food statistics collected by the food statistical data collection module 170, and Equation 3; a electricity statistics and GDP collection module 151 for collecting the data of total electricity net generation and electricity price, and the data of GDP; an energy security index calculation module 151 for calculating a energy security index using the data of the population growth rates collected by the population growth rate collection module 170, the data of total electricity net generation and electricity price and the data of GDP collected by the electricity statistics and GDP collection module 151, and Equation 4; a water poverty index and precipitation collection module 161 for collecting the data of the global water poverty index and the global precipitation; a water security index calculation module 162 for calculating a water security index using the data of the population growth rates collected by the population growth rate collection module 170, a water poverty index, the data of the global water poverty index and the global precipitation collected by the water poverty index and precipitation collection module 161, and Equation 5; a failed state index collection module 180 for collecting a failed state index indicating vulnerability of countries; and an average calculation module 110 for calculating an average of the sum of the carbon dioxide index, the temperature index, the food security index, the energy security index, the water security index and the failed state index calculated and collected by the carbon dioxide index calculation module 122, the temperature index calculation module 132, the food security index calculation module 142, the energy security index calculation module 152, the water security index calculation module 162 and the failed state index collection module 180.

While the present invention has been described with reference to the particular illustrative embodiments, it is not to be restricted by the embodiments and the ac-companying drawings but only by the appended claims. It is to be appreciated that those skilled in the art can substitute, add and modify the embodiments in various manners without departing from the scope and spirit of the present invention.

1. A method for producing a climate crisis index as an indicator indicating to the level of a risk according to climate change, wherein an average of the sum of the following indexes is produced as a climate crisis index:
a carbon dioxide(CO2) index using a carbon dioxide concentration in the atmosphere,
a temperature index using a temperature anomaly,
a food security index using food statistics,
an energy security index using total electricity net generation,
a water security index using precipitation, and
a failed state index indicating vulnerability of countries.

2. The method according to claim 1, wherein the carbon dioxide index is derived from the following Equation:
$${CO}_{2} index = \frac{x}{450 ppm} \times 100 \% ,$$
where x is a carbon dioxide concentration in the atmosphere.

3. The method according to claim 1, wherein the temperature index is derived from the following Equation:
$$Temperature index = \frac{Δ t}{5 °} \times 100 \% ,$$
where Δt is a temperature anomaly made by combining the data of a sea surface temperature and a ground surface temperature.

4. The method according to claim 1, wherein the food security index is derived from the following Equation:
$$Food security index = \frac{food consumption \times population growth rate}{\begin{matrix}( food production \times cc\_impact ) + \\ ( food imports / world population growth rate )\end{matrix}} \times 100 \% ,$$
where cc_impact is an agricultural productivity impact index providing information regarding the effects of temperature increase, precipitation change and fossil fuel use for plants on the agricultural productivity, and
the population growth rate employs data of “World Population Prospects: the 2008 Revision Population Database” provided by Population Division of the Department of Economics and Social Affairs.

5. The method according to claim 1, wherein the energy security index is derived from the following Equation:
$$Energy security index = \frac{\begin{matrix}total electricity net generation \times \\ electricity price \times population growth rate\end{matrix}}{0.1 \times GDP} \times 100 \%$$
where electricity price is a cost per KWh, and GDP is a gross domestic product (unit: one million US dollar), and
the population growth rate employs data of “World Population Prospects: the 2008 Revision Population Database” provided by Population Division of the Department of Economics and Social Affairs.

6. The method according to claim 1, wherein the water security index is derived from the following Equation:
$$Water security index = \frac{\begin{matrix}WPI \times \overline{{P}_{m}} \times \\ populationgrowthrate\end{matrix}}{{P}_{i}} ,$$
where WPI is a water poverty index as an interdisciplinary measure which links household welfare with water availability and indicates the degree to which water scarcity impacts on human populations,
P̅ₘ̅ is an average precipitation for a period from 1950 to 2008,
Pᵢ is an annual precipitation, and
the population growth rate employs data of “World Population Prospects: the 2008 Revision Population Database” provided by Population Division of the Department of Economics and Social Affairs.

7. The method according to claim 2, wherein x is a carbon dioxide concentration in the atmosphere, which was measured at Mauna Loa Observatory to the U.S. Department of Commerce.

8. The method according to claim 3, wherein Δt is a temperature anomaly calculated based on the HadCRUT3 data, which is a global temperature data made by the Hadley Center of the UK Met Office and the Climate Research Unit (CRU) of the University of East Anglia in the UK.

9. The method according to claim 1, wherein the food statistics employs the global market analysis data provided by the Food and Agricultural Organization of the United Nations, and
the failed state index employs data published by the United States think-tank Fund for Peace and the magazine Foreign Policy.

10. The method according to claim 4, wherein the cc_impact is a projected change in agricultural productivity in 2080 due to climate change forced by the use of fossil fuels or the like.

11. (canceled)

12. The method according to claim 5, wherein the total electricity net generation and the electricity price employ statistical data of the world total electricity net generation and electricity prices for households from the US Energy Information Administration, respectively.

13. The method according to claim 6, wherein the variables P̅ₘ̅ and Pᵢ employ re-analysis data of precipitations collected jointly by the National Centers for Environmental Prediction (NCEP) and the National Center for Atmospheric Research (NCAR), and the WPI (Water Poverty Index) employs a report of “The Water Poverty Index: an International Comparison” published by Centre for Economic Research to Keele University in the UK.

14-15. (canceled)

16. A system for producing a climate crisis index, comprising:
a carbon dioxide concentration collection module for collecting data of a carbon dioxide concentration in the atmosphere;
a carbon dioxide index calculation module for calculating the carbon dioxide index using the carbon dioxide concentration data collected by the carbon dioxide concentration collection module and Equation 1;
a temperature anomaly collection module for collecting a temperature anomaly;
a temperature index calculation module for calculating a temperature index using the temperature anomaly collected by the temperature anomaly collection module and Equation 2;
a population growth rate collection module for collecting the data of the population growth rate of a specific nation and the world population growth rate;
a food statistical data collection module for collecting the world food statistics;
a food security index calculation module for calculating food security index using the data of the population growth rates collected by the population growth rate collection module, the world food statistics collected by the food statistical data collection module, and Equation 3;
an electricity statistics and GDP collection module for collecting the data of total electricity net generation and electricity price, and the data of GDP;
an energy security index calculation module for calculating a energy security index using the data of the population growth rates collected by the population growth rate collection module, the data of total electricity net generation and electricity price and the data of GDP collected by the electricity statistics and GDP collection module, and Equation 4;
a water poverty index and precipitation collection module for collecting the data of the global water poverty index and the global precipitation;
a water security index calculation module for calculating a water security index using the data of the population growth rates collected by the population growth rate collection module, a water poverty index, the data of the global water poverty index and the global precipitation collected by the water poverty index and precipitation collection module, and Equation 5;
a failed state index collection module for collecting a failed state index indicating vulnerability of countries; and
an average calculation module for calculating an average of the sum of the carbon dioxide index, the temperature index, the food security index, the energy
security index, the water security index and the failed state index calculated and collected by the carbon dioxide index calculation module, the temperature index calculation module, the food security index calculation module, the energy security index calculation module, the water security index calculation module and the failed state index collection module.

17. The system according to claim 16, wherein Equation 1 is written as follows:
$${CO}_{2} index = \frac{x}{450 ppm} \times 100 \% ,$$
where x is a carbon dioxide concentration in the atmosphere, which is collected by the carbon dioxide index calculation module and measured at Mauna Loa Observatory to the U.S. Department of Commerce.

18. The system according to claim 16, wherein Equation 2 is expressed as follows:
$$Temperature index = \frac{Δ t}{5 °} \times 100 \% ,$$
where Δt is a temperature anomaly made by combining the data of a sea surface temperature and a ground surface temperature collected by the temperature anomaly collection module and calculated based on the HadCRUT3 data, which is a global temperature data made by the Hadley Center of the UK Met Office and the Climate Research Unit (CRU) of the University of East Anglia in the UK.

19. The system according to claim 16, wherein Equation 3 is written as follows:
$$Food security index = \frac{food consumption \times population growth rate}{\begin{matrix}( food production \times cc\_impact ) + \\ ( food imports / world population growth rate )\end{matrix}} \times 100 \% ,$$
where cc_impact is a projected change in agricultural productivity in 2080 due to climate change according to the use of fossil fuels or the like, and is an agricultural productivity impact index providing information regarding the effects of temperature increase, precipitation change and fossil fuel use for plants on the agricultural productivity, collected by the food statistical data collection module, and
wherein the world food statistics employs the global market analysis data provided by the Food and Agricultural Organization of the United Nations,

20. The system according to claim 16, wherein Equation 4 is written as follows:
$$Energy security index = \frac{\begin{matrix}total electricity net generation \times \\ electricity price \times \\ population growth rate\end{matrix}}{0.1 \times GDP} \times 100 \%$$
where electricity price is a cost per KWh, and GDP is a gross domestic product,
wherein the total electricity net generation and the electricity Price employ statistical data of the world total electricity net generation and electricity prices for households from the US Energy Information Administration.

21. The system according to claim 16, wherein Equation 5 is written as follows:
$$Water security index = \frac{\begin{matrix}WPI \times \overline{{P}_{m}} \times \\ populationgrowthrate\end{matrix}}{{P}_{i}} ,$$
where WPI is a water poverty index as an interdisciplinary measure which links household welfare with water availability, which is collected by the water poverty index and precipitation collection module, and employs a report of “The Water Poverty Index: an International Comparison” published by Centre for Economic Research to Keele University in the UK,
P̅ₘ̅ is an average precipitation for a period from 1950 to 2008, and
Pᵢ is an annual precipitation,
wherein the variables P̅ₘ̅ in and Pᵢ employ re-analysis data of precipitations collected jointly by the National Centers for Environmental Prediction (NCEP) and the National Center for Atmospheric Research (NCAR).

22. The system according to claim 16, wherein the population growth rate employs data of “World Population Prospects: the 2008 Revision Population Database” provided by Population Division of the Department of Economics and Social Affairs.

23. The system according to claim 16, wherein the failed state index employs data published by the United States think-tank Fund for Peace and the magazine Foreign Policy.
